(19) United States
(12) Patent Application Publication
(10) Pub. No.: US 2024/0269728 A1
(43) Pub. Date: Aug. 15, 2024

(54) DEVICE AND METHOD FOR PRODUCING WAVE WINDING WIRES FOR A COIL WINDING

(71) Applicant: GROB-WERKE GmbH & Co. KG, MINDELHEIM (DE)

(72) Inventors: Ralf RAUSCHER, FELLHEIM (DE); Dominik FENDT, URSBERG (DE); Simon FENDT, LANDSBERG (DE); Tim ZIMMERMANN, MEMMINGEN (DE)

(21) Appl. No.: 18/568,409

(22) PCT Filed: Jan. 10, 2023
(86) PCT No.: PCT/DE2023/100011

§ 371 Date: Dec. 8, 2023

(30) Foreign Application Priority Data
Jan. 11, 2022 (DE) 10 2022 000 087.3

(51) Int. Cl. B21F 1/04; H01F 41/063; H01F 41/071; H01F 41/09

(52) U.S. Cl. CPC B21F 1/04; H01F 41/063; H01F 41/071; H01F 41/09

(57) ABSTRACT

Producing wave winding wires for a coil winding of an electrical machine via flat winding. A row of shaping elements, each having a holder for a straight wire section of a wire and a bending mold for shaping a wave winding head region between the straight wire sections, are moved in a linear manner relative to one another on a linear guide mechanism and are rotated about a respective axis of rotation, in order to form a meandering wave winding wire with straight wire sections and chevron-shaped wave winding heads in between by rotating neighboring shaping elements in opposite directions with their axes of rotation converging. A change in spacing of the linear guides is converted in the rotational movement of the shaping elements. A bending of the wire ends of the wire is carried out before the meandering bending of the wave wire winding.

This application is a national phase of International Patent Application No. PCT/DE2023/100011, filed on Jan. 10, 2023, which claims the benefit of German Patent Application No. 10 2022 000 087.3, filed on Jan. 11, 2022, the entire disclosures of which are incorporated herein by way of reference.

### FIELD OF THE INVENTION

The invention relates to a wave winding production device for producing wave winding wires for a coil winding of an electric machine via flat winding. The invention further relates to a wave winding production method for producing wave winding wires for a coil winding of an electric machine via flat winding. Further, the invention relates to a controller and a computer program product having instructions for carrying out such a wave winding production method.

### BACKGROUND OF THE INVENTION

For the technological background and prior art, reference is made to the following documents:
[1] EP 1 270 104 A1
[2] WO 2017/148 619 A1
[3] US 2016/0 052 041 A1
[4] WO 2019/101 272 A1
[5] WO 2019/166 060 A1 and
[6] WO 2019/166 061 A1.

From [1], a device and a method for meandering bending of tubes for heat exchangers, such as refrigerators, are known, wherein special measures are provided against collapsing of the tubes during the bending. The bending device known from [1] comprises a linear guide mechanism and a row of shaping elements. A cylindrical bending mold for forming a round bend of the tubes is provided on each of the shaping elements. The shaping elements can be moved linearly relative to one another on the linear guide mechanism and are mounted rotatably about a respective axis of rotation in such a way that neighboring shaping elements rotate in opposite directions with their axes of rotation converging. The sequence of rotation of neighboring shaping elements is synchronized by a toothed rack and a spur gear. With this device, it is not possible to form a contour into the bend, since this can only be bent by a predetermined radius around the center of the spur gear. Furthermore, due to the nature of the toothing, a relative movement between the individual shaping elements and the tube is produced. This is not crucial for the tubes to be bent with [1], but would be disadvantageous for bending wires for coil windings which usually have an outer insulating coating. Another disadvantage is that the straight sections are not firmly clamped in the device, but are only pressed against a stop on one side.

On the other hand, when bending wires into meandering wave winding wires for coil windings, it is desirable to obtain essentially straight wire sections with wave winding heads in between which are already positioned as precisely as possible relative to one another to facilitate later insertion thereof into the component to be provided with the coil winding. Due to the parallelism of the individual straight wire sections, which is advantageous in the end, a holder is thus desirable in order to create an overbending in a defined manner and then move back again to an end position.

In contrast to [1], documents [2] to [4] concern devices and methods for producing meandering wave winding wires for a coil winding of an electrical machine via flat winding.

There are various winding methods for creating the basic shape of a wave winding. The aim of flat winding is to bend the wire with rectangular cross-section into the desired shape as gently as possible in the plane.

From [2], a device and a method are known for producing a wire segment bent into a wave shape, in particular for use as a stator winding in an electrical machine, the device comprising a linear guide mechanism and several shaping tools that are mounted for longitudinal displacement and for rotation on the linear guide mechanism and each of which has a receiving region for fixing the wire segment to be bent, the shaping tools, in order to be able to bend the wire segment fixed thereto into a wave shape, being rotatable in opposite directions and at the same time being movable towards each other along the linear guide mechanism. However, the device does not provide a solution for synchronizing the process, i.e. for coordinating the rotary and linear movements of all the shaping elements. Furthermore, the bending contour of the wire is completely undefined during the bending process, since the individual shaping elements only have mutual end stops but no connection during the actual process. The wire therefore bulges with an undefined shape. Furthermore, there is no solution for driving the device, neither for the linear movement nor for the rotational movement of the shaping elements.

Document [3] also discloses a device and a method for producing a wave-shaped wire segment. In this case, slides are displaced against each other with the aid of a spindle and simultaneously moved towards each other transversely to the pulling movement. A pantograph kinematics system ensures that the individual slides approach each other uniformly. This means that only three axes have to be electrically synchronized. In this method, the shape of the head is determined by the shape of the slide. In this method, the straight sections are not held firmly in the device, but are only straightened due to the tension between the individual slides. In this case, the load on the wire becomes very high, since the head is to be formed in the same step and the tensile force required for this directly leads to an elongation of the wire. With this device, the head bending process along with the associated shaping elements and the feed movements of the shaping elements and the wire bending behavior must be precisely matched with the longitudinal movement of the pantograph. The slightest fluctuations in the bending behavior, e.g. due to different wire qualities, result in the longitudinal axis tracking no longer matching the head bending behavior exactly, and thus the straight section of the S-shaped winding is also deformed, which leads to subsequent disadvantages when inserting the winding into the stator. With this bending method, the straight section of the winding is not guided or stabilized and remains straight only if the head shaping and longitudinal movement of the system are precisely matched and thus no resultant force acts on this conductor area. In this case, the matching must be carried out by adjusting the pantograph kinematics, which is complex and cost-intensive. For geometrical reasons, the individual shaping element can also only shape the wire by a maximum of 180° in total, i.e. the wire cannot be overbent (>180°) to compensate for springback. As soon as springback exists (which is the case with copper rods), the wire regions at the inlet and outlet will not be parallel to each other, which means that the desired straight wire region will never be exactly straight, but will always have a slight S-curvature due to the process or the system. Wire tension during bending can reduce the effect somewhat, but is also limited due to undesired cross-sectional taper.

Document [4] discloses a wave winding production device for producing wave winding wires for a coil winding of an electric machine via flat winding, comprising: a linear guide mechanism and a row of shaping elements each comprising a holder for holding a straight wire section of a wire to be bent and a bending mold for shaping a wave winding head section between the straight wire sections, the shaping elements being linearly movable relative to each other on the linear guide mechanism and rotatably supported about a respective axis of rotation such that neighboring shaping elements rotate in opposite directions, from a basic position in which the holders of the shaping elements are aligned with each other, with their axes of rotation approaching each other in order to form a meandering wave winding wire with straight wire sections and chevron-shaped wave winding heads therebetween from the wire held in the holders.

With the device known from the most relevant prior art according to [4], the shaping elements are rotatably supported on the carriages of one or more linear guide mechanisms and coupled via a toothing. This enables the shaping elements to be rotated in opposite directions, with the rotation being controlled solely by moving the carriages together along the linear guide mechanism. By transmitting the rotational movement from one shaping element to the following one, this can also be referred to as “series connection” in which the angle of rotation of the shaping elements depends decisively on their longitudinal position.

The mutual rolling along the special pitch curve allows a constant tension in the wire during the bending, which makes it possible to produce complex head shapes and prevent deformation of the straight sections. The toothing provides positive locking in addition to the frictional locking along the pitch curve, which is intended to ensure synchronous rotating.

The main work steps are explained below.

Initially, in a basic position, the shaping elements with their holders are aligned with each other so that the holders form a straight-line receptacle. In this initial position, the wire is inserted into the straight fixture.

The shaping elements are then moved together evenly and rotated in opposite directions.

In the end position, the straight wire sections held in the holders lie substantially parallel to each other, adjacent straight wire sections being alternately connected on one side or the other by a chevron-shaped winding head which has been formed by corresponding bending molds on the shaping elements.

After reaching the end position, one or more punches are extended to form a counterbend in the winding head. Counterbending shapes the wire exactly along the desired contour and also reduces springback of the wire after it has been removed from the shaping elements. During counterbending, the wire ends are bent along the contour of the outer shaping elements using independent actuators.

The device and the method as described in [4] have proven themselves. However, there is still further potential for improvement.

For example, when the rotational movement is initiated on one side, the first shaping elements turn more quickly due to the play in the toothing. This change in length could then also lead to a loss of synchronization (tooth is skipped).

If the shaping elements lose contact in the longitudinal direction, a loss of synchronization can also occur, especially in the case of movements without wire, which is possible for example during the commissioning of such a system.

### SUMMARY OF THE INVENTION

Based on document [4], it is an object of the invention to further improve a device and a method for producing wave winding wires for a coil winding of an electrical machine via flat winding.

To achieve this object, the invention provides wave winding production devices and wave winding production methods according to one or more embodiments described herein.

Advantageous embodiments are the subject of further embodiments.

According to a first aspect, the invention provides a wave winding production device for producing wave winding wires for a coil winding of an electric machine via flat winding, comprising:
a linear guide mechanism and
a row of shaping elements each comprising a holder for holding a straight wire section of a wire to be bent and a bending mold for shaping a wave winding head region between the straight wire sections, the shaping elements being linearly movable relative to each other on the linear guide mechanism and rotatably supported about a respective axis of rotation such that neighboring shaping elements rotate in opposite directions, from a basic position in which the holders of the shaping elements are aligned with each other, with their axes of rotation approaching each other in order to form a meandering wave winding wire with straight wire sections and chevron-shaped wave winding heads therebetween from the wire held in the holders,
wherein the linear guide mechanism comprises a first linear guide and a second linear guide whose spacing from each other is variable,
wherein further a converter mechanism is provided for converting a change in spacing of the first linear guide and the second linear guide into the rotational movement of the shaping elements.

It is preferred that the converter mechanism has one converter for each shaping element to be rotated, which converter is mounted on the linear guide mechanism so as to be movable along with the associated shaping element.

It is preferred that the row of shaping elements includes alternating first and second shaping elements, the second shaping elements being designed for rotation in the opposite direction to the first shaping elements,
wherein the linear guide mechanism comprises a third linear guide, the first linear guide being disposed between the second and third linear guides, and the second and third linear guides being movable towards and away from the first linear guide for driving the rotational movement,
wherein first converters for driving the rotational movement of the first shaping elements comprise first pick-off elements which are linearly movably mounted on the second linear guide, and second converters for driving the rotational movement of the second shaping elements comprise second pick-off elements which are linearly movably mounted on the third linear guide.

It is preferred that the converters have lever kinematics for converting the movement of the linear guides towards and away from each other into a rotational movement of the associated shaping elements.

It is preferred that the first linear guide comprises a stationary guide rail on which guide carriages are mounted to be freely displaceable, on which guide carriages a respective shaping element is rotatably mounted with its axis of rotation, and that the second linear guide has a distributor rail which is mounted to be displaceable transversely to the extension of the guide rail.

A preferred embodiment of the wave winding production device comprises an actuator for changing the spacing between the linear guides of the linear guide mechanism.

A preferred design of the wave winding production device comprises a first actuator for driving the movement of the second linear guide and a second actuator coupled to or synchronized with the first actuator for driving the movement of the third linear guide.

A preferred design of the wave winding production device comprises a coupling mechanism for coupling the actuator to the second linear guide and the third linear guide.

It is preferred that shaping elements are mounted to the linear guide mechanism in such a way that they can be replaced individually.

It is preferred that the shaping elements are freely displaceable relative to each other on the linear guide mechanism and that neighboring shaping elements are engaged with each other via at least one mechanical cam in such a way that the relative displacement of the shaping elements to each other is driven via the rotation of the shaping elements.

It is preferred that neighboring shaping elements are adapted to roll off each other on a pitch curve during the rotational movement.

It is preferred that neighboring shaping elements are adapted to bear against each other on pitch curves during the entire rotational movement for shaping the wave winding wire.

A preferred design of the wave winding production device comprises a pressing force introduction device which is adapted to introduce, via the pitch curve(s), a pressing force for maintaining the support of neighboring shaping elements when the shaping elements are moved together and/or apart.

It is preferred that the pressing force introduction device is adapted to introduce a force independent of the direction of rotation of the shaping elements into a guide carriage of at least one outer shaping element of the row of shaping elements, which guide carriage is movable on the linear guide mechanism.

It is preferred that the other outer shaping element of the row of shaping elements is fixed to the linear guide mechanism and/or that the pressing force introduction device is adapted to introduce a pressing force into at least one further guide carriage of a further shaping element, which guide carriage is movable on the linear guide mechanism.

It is preferred that the pressing force introduction device is adapted to introduce a pressing force by moving a plurality of shaping elements towards each other.

It is preferred that the pressing force introduction device comprises at least one preferably elastic clamping device for introducing a clamping force for clamping together neighboring shaping elements.

According to a further aspect, the invention provides a wave winding production device for producing wave winding wires for a coil winding of an electric machine via flat winding, comprising:
a linear guide mechanism and
a row of shaping elements each comprising a holder for holding a straight wire section of a wire to be bent and a bending mold for shaping a wave winding head region between the straight wire sections, the shaping elements being linearly movable relative to each other on the linear guide mechanism and rotatably supported about a respective axis of rotation such that neighboring shaping elements rotate in opposite directions, from an initial position in which the holders of the shaping elements are aligned with each other, with their axes of rotation converging so as to form a meandering wave winding wire including straight wire sections and chevron-shaped wave winding heads therebetween from the wire held in the holders,
and a wire-end bending and fixing device adapted to bend the ends of the wire to be bent inserted into the linearly aligned holders prior to the rotational movement of the shaping elements and to positively fix them to the associated outer shaping element.

Preferably, the wave winding production device comprises both the features of the first aspect or the features of one of the advantageous designs thereof and the features of the second aspect or the features of one of the advantageous designs thereof.

It is preferred that the wire-end bending and fixing device is configured to bend the wire ends in such a way that wire ends protruding from the outer shaping elements are offset parallel to the wire sections received in the holder.

It is preferred that the wire-end bending and fixing device is adapted to shape the wire ends on an outer bending mold of the outer shaping elements.

According to a third aspect, the invention provides a wave winding production method for producing wave winding wires for a coil winding of an electrical machine via flat winding, comprising:
a) providing a row of shaping elements each comprising a holder for holding a straight wire section of a wire to be bent and a bending mold for shaping a wave winding head region between the straight wire sections, the shaping elements being linearly movable relative to each other and rotatably supported about a respective axis of rotation,
b) inserting a wire into the mutually aligned holders of the shaping elements,
c) driving opposite rotational movements of neighboring shaping elements by changing a spacing of linear guides of a linear guide mechanism for guiding the linear movement of the shaping elements and converting the change in spacing into rotational movements of the shaping elements,
d) bending, by the opposite rotational movements, a meandering wave winding wire having straight wire sections and chevron-shaped wave winding heads therebetween.

It is preferred that step c) comprises the steps of:
guiding the linear movement of the shaping elements on a first linear guide and displacing a second and/or a third linear guide relative to the first linear guide in a direction transverse to the direction of linear movement of the shaping elements and
picking off the relative displacement movement of the linear guides by means of pick-off elements of converters displaceably mounted on the second and/or third linear guide, which converters are respectively assigned to the shaping elements and move along with the assigned shaping elements in the direction of linear movement.

It is preferred that in step c) the first linear guide is held stationary and the second and/or third linear guide is moved towards and away from the first linear guide as a distributor rail.

It is preferred that the linear position of the shaping elements relative to one another is set by mutually supporting neighboring shaping elements on pitch curves.

Preferably, the wave winding production method comprises the step of: introducing a pressing force to maintain the support of neighboring shaping elements via the pitch curves when the shaping elements are moved together and/or when they are moved apart.

It is preferred that introducing the pressing force comprises introducing a force independent of the direction of rotation of the shaping elements into a guide carriage of at least one outer shaping element, which guide carriage is movable on a linear guide mechanism.

It is preferred that the introduction of the pressing force further comprises introducing at least one further force into at least one further guide carriage of a further shaping element, which guide carriage is movable on the linear guide mechanism.

It is preferred that the introduction of the pressing force comprises the relative linear movement of a plurality of shaping elements.

It is preferred that the introduction of the pressing force comprises the introduction of a preferably elastic clamping force for clamping together neighboring shaping elements.

According to a fourth aspect, the invention provides a wave winding production method comprising:
aa) meandering bending of a wire into a wave winding having straight wire sections interconnected by wave winding heads, and
bb) bending wire ends of the wire, wherein step bb) is carried out prior to step aa).

In a preferred design, the wave winding production method according to the fourth aspect also comprises the steps of the wave winding production method according to the third aspect or of an advantageous design thereof.

It is preferred that step bb) comprises positively fixing the wire ends to outer shaping elements of a wave winding production device for performing step aa).

Preferably, step bb) is performed such that the bent-over wire ends are offset parallel to the next adjacent straight wire section.

Preferably, the or at least some of the wire ends are bent over in step bb) to form connecting wires for connecting the wave winding wire, in particular to an interconnection element for connecting the coil mat or coil winding.

Preferably, the wave winding production method according to any one of the preceding designs uses a wave winding production device according to any one of the preceding designs.

Preferably, the wave winding production device comprises an electronic controller adapted to control the wave winding production device to perform the wave winding production process according to any of the preceding designs.

According to a further aspect, the invention provides a controller for a wave winding production device according to any one of the preceding designs, which controller is adapted to control the wave winding production device to perform the wave winding production process according to any one of the preceding designs.

The controller is preferably an electronic controller, more preferably configured as a computing device with appropriately loaded software.

A further aspect of the invention relates to corresponding software. In particular, according to the further aspect, the invention provides a computer program comprising machine-readable instructions for causing a wave winding production device according to any one of the preceding designs to perform the wave winding production method according to any one of the preceding designs.

The meandering wave winding wires that can be produced by preferred designs of the device and method, comprise substantially parallel straight wire sections and chevron-shaped wave winding heads therebetween. The straight wire sections are preferably intended and adapted to be inserted into grooves of the component to be provided with the wave winding. The straight wire sections are accordingly aligned parallel to each other, but may also deviate from the strictly parallel direction due to springbacks.

Preferred designs of the invention relate to devices and methods for producing wave winding wires via flat winding, wherein several of these wave winding wires can be joined together to form a coil mat, for example as described and shown in documents [5] and [6]. For further details on the possible configurations of the wave winding wires, reference is explicitly made to [5] and [6].

In devices according to preferred embodiments, the shaping elements are driven with lever kinematics.

### BRIEF DESCRIPTION OF THE DRAWINGS

Embodiments of the invention are explained in more detail below with reference to the attached drawings. In the drawings it is shown by:

FIG. 1 a plan view of a preferred embodiment of a wave winding production device for producing a wave winding wire bent in a meander shape, in a basic position;

FIG. 2 a view as in FIG. 1 of the wave winding production device in an intermediate position;

FIG. 3 a view as in FIGS. 1 and 2 of the wave winding production device in an end position;

FIG. 4 an enlarged detail of FIG. 2;

FIG. 5 a perspective view of one of the shaping elements of the wave winding production device with an embodiment of a linear guide mechanism and a converter mechanism;

FIG. 6 a schematic block diagram of the wave winding production device;

FIG. 7 a lateral view of a row of shaping elements with linear guide in a first embodiment of the wave winding production device in an initial position;

FIG. 8 a schematic plan view of the row of shaping elements of FIG. 7 in an end position;

FIG. 9 a lateral view of the row of shaping elements with linear guide in a second embodiment of the wave winding production device in the initial position;

FIG. 10 a lateral view of the row of shaping elements with linear guide in a third embodiment of the wave winding production device in the initial position;

FIG. 11 a lateral view of the row of shaping elements with linear guide in a fourth embodiment of the wave winding production device in the initial position;

FIG. 12 a lateral view of the row of shaping elements with linear guide in a fifth embodiment of the wave winding production device in the initial position;

FIG. 13 a plan view of a row of shaping elements of a sixth embodiment of the wave winding production device in the initial position when a wire to be bent is inserted; and

FIG. 14 the plan view of FIG. 13 after a first step of a forming process for producing the wave winding wire, in particular for forming a lead wire.

### DETAILED DESCRIPTION OF THE PREFERRED EMBODIMENTS

In the accompanying Figures, various embodiments of a wave winding production device 10 are shown. The wave winding production device 10 is designed for producing wave winding wires for a coil winding of an electrical machine via flat winding.

As described and shown in particular in documents [5] and [6], it is possible to assemble winding mats—also called coil mats—from wave winding wires for producing a coil winding of an electric machine. A winding mat is understood to be a mat-shaped conductor bundle formed from several wave winding wires (conductors). Wave winding wires are wires bent in a wave-like manner, in which case the bend is produced in a single plane by bending successive wire sections in opposite bending directions using the wave winding production device 10 shown here and applying the wave winding production methods which can be carried out with the device. Such a production method is particularly advantageous for profiled wires which have a cross-sectional profile deviating from a round shape, for example a rectangular profile. For example, the wires are formed from copper wire with a rectangular profile. In particular, the wires are provided with an outer insulating layer for electrical insulation, which is to remain un-damaged during bending. Windings made of wave winding wires and winding mats differ from so-called sword windings, in which a coil winding is made by winding onto an elongated rectangular mold (sword), and the (sword) winding mats formed therefrom differ in that the wires are not bent in a spiral or helical shape, but are bent flat. In particular, a winding mat comprises a plurality of winding wires bent in a wave shape extending in a longitudinal direction and having longitudinally spaced straight wire sections extending in a transverse direction transverse to the longitudinal direction and chevron-shaped winding heads therebetween such that adjacent straight wire sections are interconnected by a winding head bent in a chevron shape.

The straight wire sections of the winding mat serve in particular to be inserted into grooves of a housing of a component of an electric machine, such as in particular a stator of an electric motor. The winding heads each form a turnback and project externally from the axially directed housing ends, connecting the wire section of one slot to a wire section in another slot. Altogether, the coil winding of the component of the electrical machine can thus be formed by one or preferably several winding mats. For example, a three-phase coil winding is to be produced. The wave winding production device 10 described in more detail herein and the methods that can be performed therewith deal with the step of manufacturing such a wire bent in a wave shape, which wires can be assembled in different ways—in particular stacking, pinning or braiding—to form a winding mat.

According to the accompanying Figures, the wave winding production device 10 has a linear guide mechanism 12 and a chain or row of shaping elements 14.1, 14.2.

In the Figures, the wave winding production device 10 is shown simplified for illustrative purposes with only three shaping elements 14.1, 14.2. With three successive shaping elements, it is possible to form a “wave” with a first winding head pointing in a first direction and a second winding head pointing in the other direction. It should be clear that in practice a correspondingly larger number of shaping elements 14.1, 14.2 may be provided depending on the length of the wave winding wire and the number of winding heads to be produced.

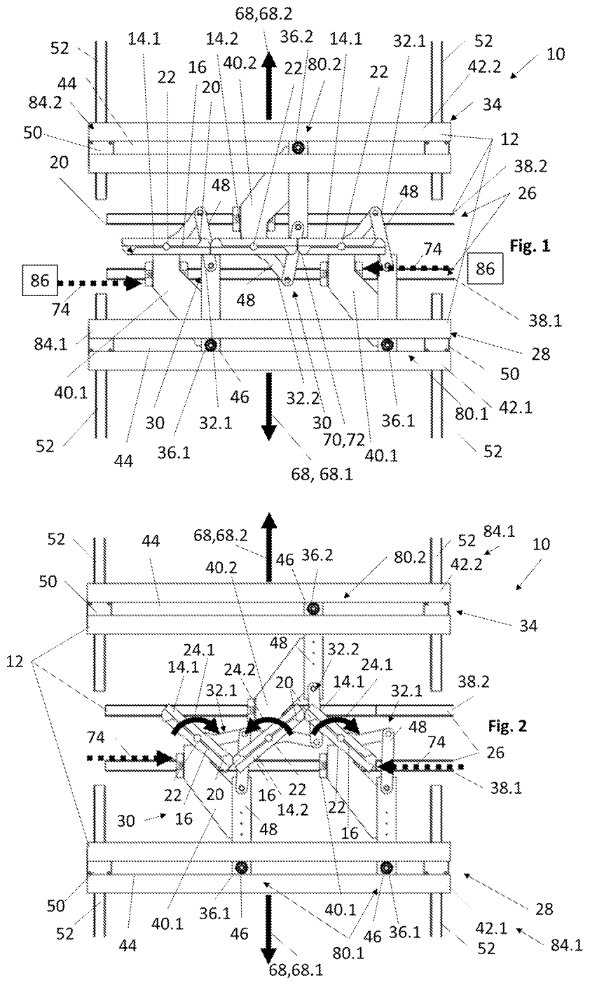

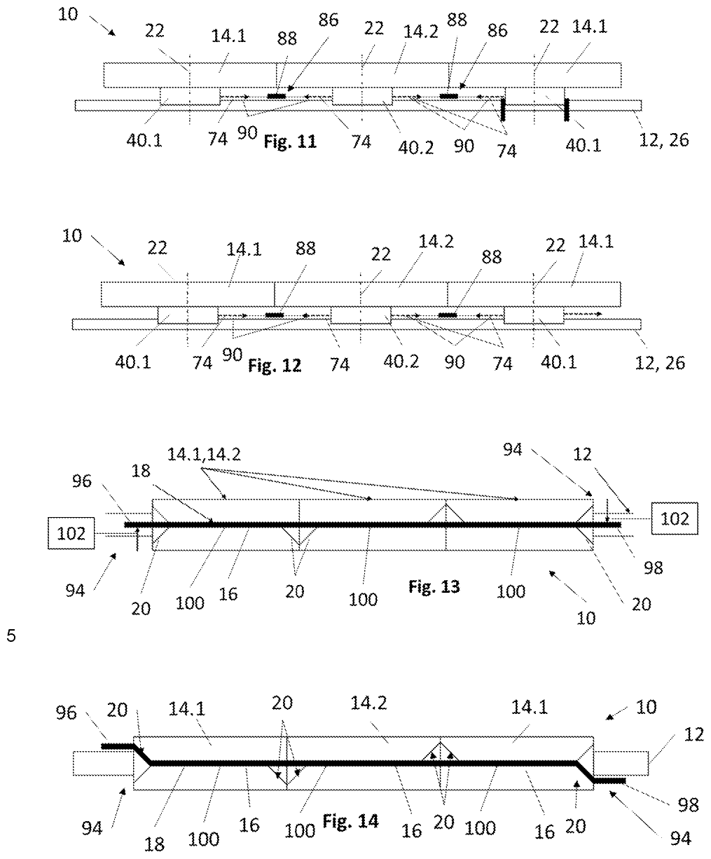

As can be seen in particular from FIGS. 1 to 5, each shaping element 14.1, 14.2 has a respective holder 16 for holding a straight wire section of a wire 18 to be bent (an example is shown in FIGS. 12 and 13) and a bending mold 20 for shaping a wave winding head region between the straight wire sections.

As is known in principle from [4], to which reference is made for further details, the holder 16 may be formed by a groove in the shaping element 14.1, 14.2, which bounds the wire 18 on both sides and thus fixes it during bending. The bending mold 20 is designed for shaping the winding head. Depending on the dimensions and shape of the winding head, the bending mold 20 may vary—even from shaping element 14.1 to shaping element 14.2. in the shaping element chain.

The shaping elements 14.1, 14.2 can be moved linearly relative to one another on the linear guide mechanism 12 and are each mounted so as to be rotatable about an axis of rotation 22.

FIG. 1 shows a basic position in which the holders 16 of the shaping elements 14.1, 14.2 are aligned with each other. In this basic position, the wire 18 is inserted as shown in FIG. 12.

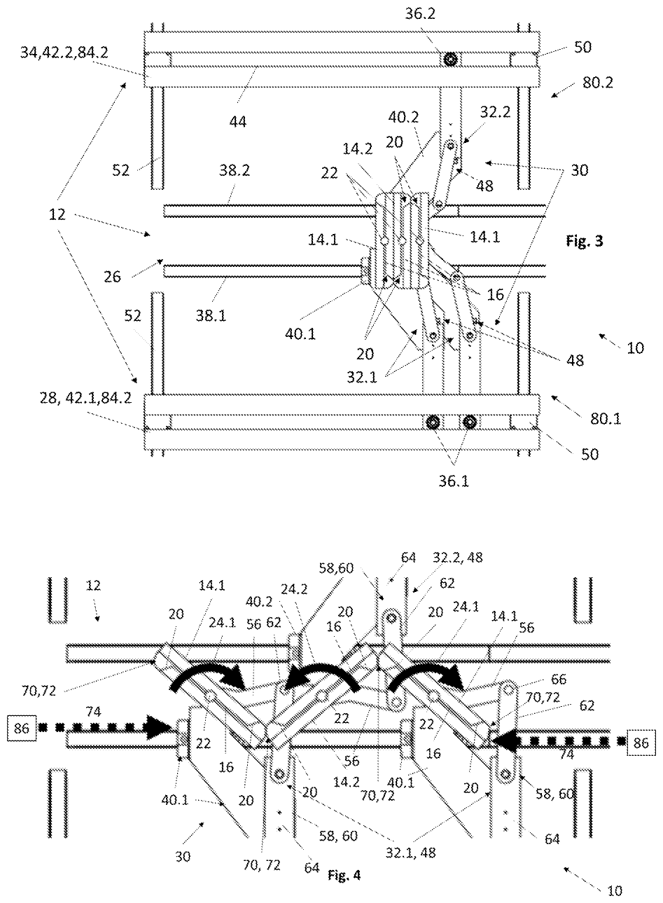

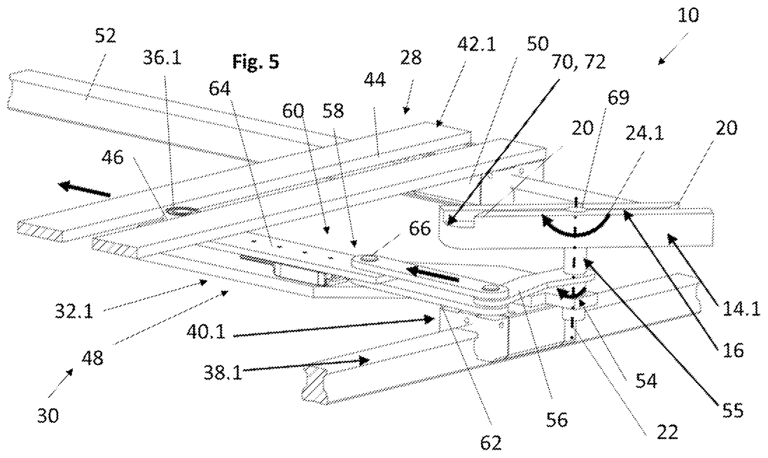

FIG. 2 shows an intermediate position of the wave winding production device 10, while FIG. 3 shows an end position of the wave winding production device 10. FIG. 4 shows an enlarged view of the shaping elements 14.1, 14.2 of FIG. 2. FIG. 5 shows an assembly of one of the shaping elements 14.1 together with a converter 32.1 for driving a rotational movement of the shaping element 14.1.

As can be seen from the sequence of FIGS. 1 to 3, the shaping elements 14.1, 14.2 are mounted on the linear guide mechanism 12 in such a way that, from the basic position, neighboring shaping elements 14.1, 14.2 respectively rotate in opposite directions to one another and the shaping elements 14.1, 14.2 thereby approach one another with their axes of rotation 22.

Thus, during rotating and approaching, as is known in principle from [4], the meandering wave winding wire with straight wire sections and chevron-shaped wave winding heads therebetween is formed from the wire 18 held in the holders 16.

As shown in FIGS. 1 to 5, in some embodiments, the linear guide mechanism 12 has a first linear guide 26 and a second linear guide 28, whose spacing from each other is variable.

Referring to FIGS. 1 to 5, some embodiments of the wave winding production device 10 further comprise a converter mechanism 30. The converter mechanism 30 is configured to convert a change in the spacing between the first linear guide 26 and the second linear guide 28 into the rotational movement of the shaping elements 14.1, 14.2.

In some embodiments, the converter mechanism 30 has one converter 32.1, 32.2 for each shaping element 14.1, 14.2 to be rotated, which converter is mounted on the linear guide mechanism 12 so as to be movable together with the associated shaping element 14.1, 14.2.

The shaping elements rotating in the first direction of rotation 24.1 are hereinafter referred to as first shaping elements 14.1, while the shaping elements rotating in the second direction of rotation 24.2 are hereinafter referred to as second shaping elements 14.2. In the row of shaping elements, first shaping elements 14.1 and second shaping elements 14.2 are always provided alternately. Each pair of first and second shaping elements 14.1, 14.2 together form a chevron-shaped wave winding head when rotated.

For example, in the embodiments shown, the first linear guide 26 serves as a linear guide for the shaping elements 14.1, 14.2, while the second linear guide 28 is configured as a distributor for distributing a rotational force to the first shaping elements 14.1.

In some embodiments, it is sufficient if only some of the shaping elements 14.1, 14.2 are rotationally driven by means of the converter mechanism 30. For example, only the first shaping elements 14.1 are rotationally driven by means of the converter mechanism 30, while the intermediate second shaping elements 14.2 are coupled, for example in the manner known from [4], by means of teeth, and/or pitch curves and/or other control cams and control cam follower elements via which they are engaged with each other.

In preferred embodiments, as shown in FIGS. 1 to 5, the row of shaping elements comprises alternating first and second shaping elements 14.1, 14.2, the second shaping elements 14.2 being adapted to rotate in opposite directions to the first shaping elements 14.2. The linear guide mechanism 12 comprises a third linear guide 34. The first linear guide 26 is arranged between the second linear guide 28 and the third linear guide 34. The second and third linear guides 28, 34 are movable toward and away from the first linear guide 26 for driving the rotational movement. In particular, the third linear guide 34 is configured to distribute a rotational force for driving the rotational movement to the second shaping elements 14.2.

For driving the rotational movement of the first shaping elements 14.1, first converters 32.1 have first pick-off elements 36.1, which are linearly movably mounted on the second linear guide 28. Second converters 32.2 have second pick-off elements 36.2 for driving the rotational movement of the second shaping elements 14.2, which second pick-off elements 36.2 are linearly movably mounted on the third linear guide 34.

The configuration of the linear guides 26, 28, 34 can be different. The way in which the linear guides 26, 28, 34 are adjustable in spacing from one another can also be different. Preferably, one of the linear guides 26, in particular the first linear guide 26 for guiding the linear movement of the shaping elements 14.1, 14.2, is held stationary, for example mounted on a machine frame, while the other linear guide(s)—in particular the second linear guide 28 and, if provided, the third linear guide 34—are movable towards and away from the one linear guide—in particular the first linear guide 26.

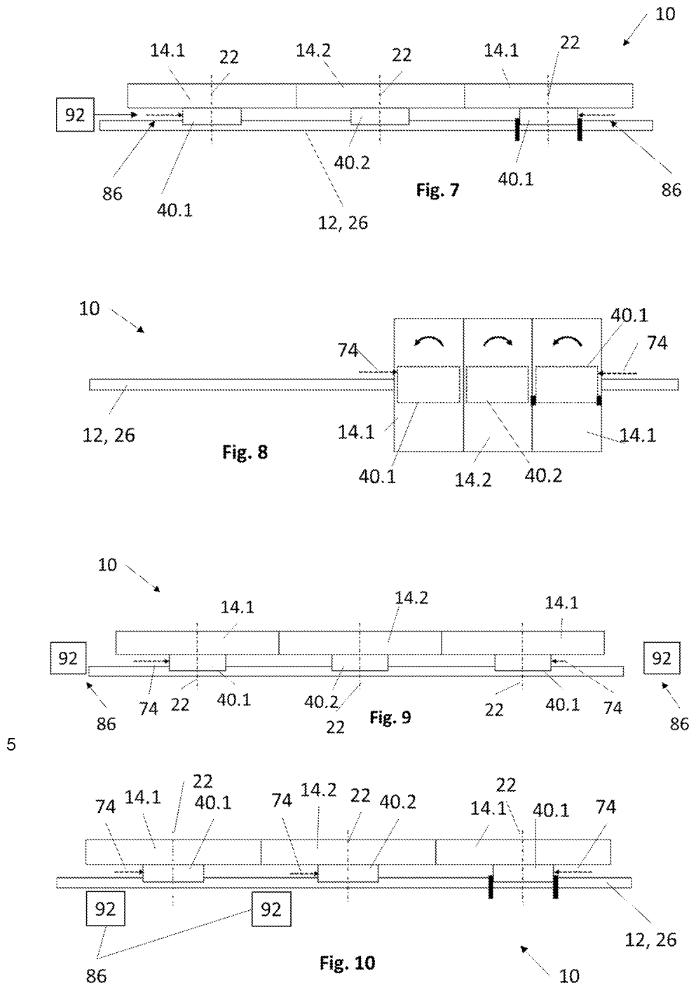

Accordingly, in some embodiments, the first linear guide 26 has at least one stationary guide rail 38.1, 38.2, on which guide carriages 40.1, 40.2 are mounted for free displacement, on each of which a shaping element 14.1, 14.2 is rotatably mounted with its axis of rotation 22. This does not mean that all shaping elements 14.1, 14.2 must be freely displaceable on the first linear displacement device 26. As explained later with reference to FIGS. 7 to 12, in some embodiments, one of the shaping elements 14.1, 14.2, in particular a shaping element arranged at the end of the row of shaping elements 14.1, 14.2, is fixed to the first linear guide 26, while the other shaping elements 14.1, 14.2 are freely linearly movable on the first linear guide 26 in order to move towards this fixed shaping element for bending the wire and away from it again for assuming the basic position.

In the embodiments shown in FIGS. 1 to 5, the first linear guide 26 has a first guide rail 38.1, on which first guide carriages 40.1 are mounted. One of the first shaping elements 14.1 is rotatably mounted with its axis of rotation 22 on a respective first guide carriage 40.1. The first linear guide 26 further has a second guide rail 38.2, on which two second guide carriages 40.2 are mounted. One of the second shaping elements 14.2 is rotatably mounted with its axis of rotation 22 on a respective second guide carriage 40.2.

In some embodiments, the second linear guide 28 and/or—if provided—the third linear guide 34 each has a distributor rail 42.1, 42.2, which is mounted so as to be displaceable transversely to the extension of the at least one guide rail 40.1, 40.2.

As can be seen in particular from FIG. 5, guides 52 for displacing the respective distributor rail 42.1, 42.2 away from the first linear guide 26 extend in a direction transverse to the extension of the first linear guide 26. The distributor rail 42.1, 42.2 is arranged on a distributor rail carriage 50, which travels on these guides 52.

In the embodiment of FIGS. 1 to 5, the second linear guide 28 has a first distributor rail 42.1 with a slot 44 or a groove in which rollers 46 of the first pick-up elements 36.1 are received in a displaceable manner. The third linear guide 34 has a second distributor rail 42.1 with a corresponding slot 44 or groove, in which rollers 46 of the second pick-off elements 36.2 are received in a displaceable manner.

In particular, two beams are arranged on the distributor rail carriage 50 in the first and second distributor rails 42.1, 42.2, between which the respective slot 44 is formed for receiving the rollers 46 or the other pick-off elements 36.1, 36.2.

The conversion of the change in spacing of linear guides 26, 28, 34 into rotational movements can be carried out by means of any suitable gear. The conversion is preferably carried out mechanically, so that no connections have to be made to the moving shaping elements 14.1, 14.2 or their guides. In this way, the advantages explained in more detail below can be achieved simply and reliably, and high speeds can be achieved for short cycle times in large-scale industrial production.

In some embodiments, the converters 32.1, 32.2 include lever kinematics 48 for converting the movement of the linear guides 26, 28, 34 toward and away from each other into rotational movement of the associated shaping elements 14.1, 14.2. An embodiment of such lever kinematics 48 for forming a converter 32.1 is shown in FIG. 5.

In FIG. 5, a first unit consisting of the first shaping element 14.1, the first guide carriage 40.1, the first guide rail 38.1 and the associated first converter 32.1 with the first distributor rail 42.1 is shown. A corresponding second unit consisting of the second shaping element 14.2, the second guide carriage 40.2, the second guide rail 38.2, the second converter 32.2 and the second distributor rail 42.2 is correspondingly mirror-symmetrical and therefore not shown again. According to FIG. 5, the guide carriage 40.1 is mounted for free displacement on the associated guide rail 38.1. A pivot bearing 54, comprising a pivot pin for example, is provided on the guide carriage 40.1 for rotatably supporting the shaping element 14.1. The shaping element 14.1 is connected in a rotationally fixed manner (for example, by means of a rotationally rigid connection 55) to a cantilever 56. The free end of the arm of the cantilever 56 is connected to a lever unit 58, at the other end of which the pick-off element 36.1, here with the roller 46, is arranged. The lever unit 58 may comprise one or more lever rods. In the illustrated embodiment, the lever unit 58 includes a toggle lever 60 having a first toggle arm 62, a second toggle arm 64, and an articulated joint 66 therebetween. The first toggle arm is hinged at one end to the cantilever 56, and is hinged at the other end to the second toggle arm 64 by means of the articulated joint 66. The second toggle arm 64 is mounted on the guide carriage 40.1 so as to be linearly displaceable in the direction transverse to the travel movement of the guide carriage 40.1, and has the pick-off element 36.1 at its end facing away from the articulated joint 66.

When the second linear guide 28 moves away from the first linear guide 26, the lever unit 58 is pulled along and rotates the connected shaping element 14.1 by means of the cantilever 56.

Some embodiments include an actuator 68 for varying the spacing of the linear guides of the linear guide mechanism. In some embodiments, this includes a first actuator 68.1 for driving the movement of the second linear guide 28 and a second actuator 68.2 coupled to or synchronized with the first actuator 68.1, for driving the movement of the third linear guide 34. In other embodiments, a coupling mechanism is provided for coupling the actuator 68 to the second linear guide 26 and the third linear guide 34. For example, the actuator 68, 68.1, 68.2 may comprise a preferably electromechanically acting cylinder, wherein the cylinder movement is transmitted to the linear guides by a suitable transmission, or wherein coupled cylinders may be provided.

As can be seen in particular from FIGS. 4 and 5, the neighboring shaping elements 14.1, 14.2 are not directly connected to one another, rather the shaping elements 14.1, 14.2 are individually interchangeably mounted on the linear guide mechanism 12. For this purpose, the shaping elements 14.1, 14.2 are rotatably mounted on the rotary pin and fastened with a detachable screw 69 for example.

The shaping elements 14.1, 14.2 are mounted on the linear guide mechanism 12 so as to be freely displaceable relative to one another. Neighboring shaping elements 14.1, 14.2 are engaged with each other via at least one mechanical control cam 70 in such a way that the relative displacement of the shaping elements 14.1, 14.2 with respect to each other is driven via the rotation of the shaping elements 14.1, 14.2.

This can be done via differently designed control cams 70. For example, in each case the first shaping element 14.1 could be provided with a control cam, and the adjacent second shaping element has a control cam follower element, for example a roller or sliding pin or the like, which contacts the control cam 70 and travels along it to drive the displacement movement of the second shaping element 14.2 relative to the first shaping element 14.2.

In the embodiments shown, as can be seen in particular in FIGS. 4 and 5, neighboring shaping elements 14.1, 14.2 are designed to roll mutually on a pitch curve 72 as a control cam 70 during the rotational movement. In particular, pitch curves 72 are provided at both ends of the shaping elements 14.1, 14.2, respectively, which are designed in such a way that the neighboring shaping elements 14.1, 14.2 are supported against each other on their pitch curves 72 during the entire rotational movement for shaping the wave winding wire. The shaping elements 14.1, 14.2 are driven to rotate by means of the lever kinematics 48 and bend the wire 18. Due to the resistance during bending, a pressing force 74 is generated by which the shaping elements 14.1, 14.2 are supported on one another via their pitch curves 72. By said pressing force 74 and while rolling over the pitch curves 72, the shaping elements 14.1, 14.2 on the linear guide mechanism 12 are moved from the initial position shown in FIG. 1 to the end position shown in FIG. 3.

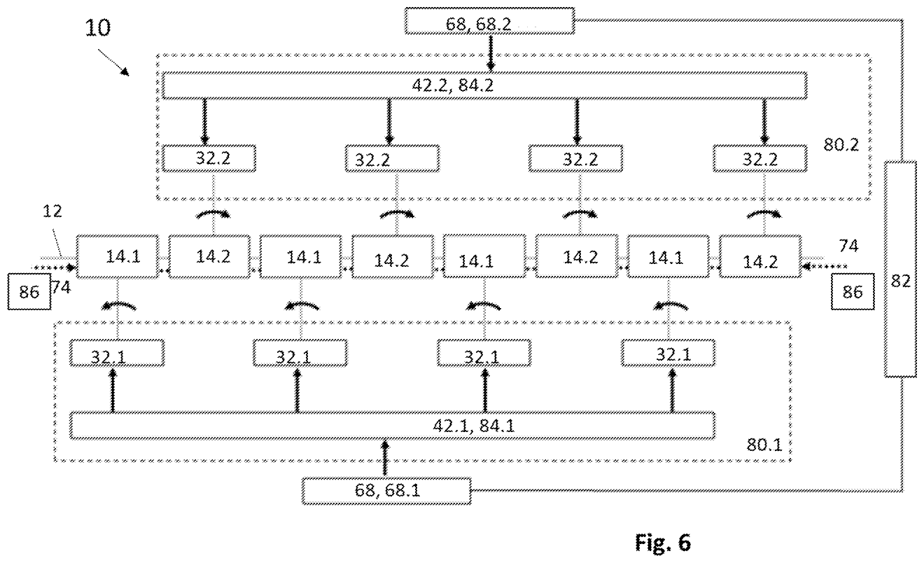

FIG. 6 shows a schematic block diagram for preferred embodiments of the wave winding production device 10, on the basis of which particular functions and advantages of the configurations comprising linear guides movable relative to one another will be explained in the following.

Up to now, for the production of the wave winding wires according to [4], a synchronization of the movement of the shaping elements has been carried out by driving one of the shaping elements and interlocking respective neighboring shaping elements. Such a “series connection” of the shaping elements described in [4] leads to high forces at the toothing of the shaping element at which the movement is initiated. These forces will increase further with simultaneous bending of multiple wires and a high number of shaping elements, leading to the risk of mechanical failure or skipping of the toothing. Likewise, with such a procedure, the rotation of the shaping elements is not exactly synchronized due to the summation of the manufacturing tolerances. As a result, the angle of rotation at the shaping elements of the introductory guide carriage is greater than at the opposite end of the chain of shaping elements. In addition, the flexibility of the known wave winding production device is considerably limited by the toothing necessary for the transmission of the rotational movement. The toothing, together with the pitch curve, depends primarily on the geometry of the wire. Thus, even minor changes and optimizations of the wire contour may lead to costly design adjustments in the region of the toothing. In addition to the costs and resource requirements for redesigning or adapting the toothing, the associated manufacturing effort and production times, which are incurred for the toothing as well each time the shaping elements are changed, must also be considered a negative aspect.

The complexity resides in the large number of parameters that affect the contour of the shaping elements 14.1, 14.2. Depending on the stator geometry and the winding scheme, it is possible that each shaping element 14.1, 14.2 of the chain differs from the others. Furthermore, in running-in of the process, individual shaping elements 14.1, 14.2 may change independently of the others and should therefore not be related to the basic kinematics or synchronization. Furthermore, in [4], the mutual rolling along the pitch curve results in a nonlinear longitudinal movement of the shaping elements 14.1, 14.2 relative to each other. Thus, on the one hand, the individual longitudinal movements are very complex to synchronize, and on the other hand, they depend on the pitch curve and thus on the contour of the shaping element.

In contrast, in embodiments of the wave winding production device 10 shown here, the rotation of the shaping elements 14.1, 14.2 is precisely not controlled by the initiation of one or more longitudinal movements. Thus, the non-linear motion curves do not have to be calculated and programmed again at great expense after each change of a shaping element 14.1, 14.2.

Embodiments of the wave winding production device 10 have reversible basic kinematics 80.1, 80.2 that do not depend on the changing contour of the shaping element 14.1, 14.2 and act independently of the linear position of the shaping elements 14.1, 14.2. At the same time, synchronized rotation of all shaping elements 14.1, 14.2 can be ensured. In this case, the function of synchronization is taken from the shaping element 14.1, 14.2 and integrated into the independent basic kinematics 80.1, 80.2. An early distribution of the applied forces within the basic kinematics 80.1, 80.2 is realized. This helps to keep the force peaks at the shaping element 14.1, 14.2 low.

Inexpensive shaping elements 14.1, 14.2 can be used, which can be mounted on the basic kinematics 80.1, 80.2 and exchanged in case of modifications without affecting the kinematics.

The embodiments of the wave winding production device 10 shown here have basic kinematics 80.1, 80.2 in the form of linear guides 26, 28, 34 with variable spacing, with a converter mechanism 30 for converting the change in spacing into rotational movements of the shaping elements 14.1, 14.2.

Following the fixing of the wire in the holders 16, the angularly synchronous rotation of the shaping elements 14.1, 14.2 is initiated and continuously controlled by means of the basic kinematics 80.1, 80.2 which are independent of the shaping element 14.1, 14.2. The basic kinematics 80.1, 80.2 distributes the force for rotation evenly with the aid of a parallel connection and transmits the individual forces synchronously to the respective shaping elements 14.1, 14.2. The mechanism enables a kind of freewheeling in the longitudinal direction—direction of the linear movement guided by linear guide—whereby the rotation of the shaping elements 14.1, 14.2 takes place independently of their position.

The control for deflection of the shaping elements 14.1, 14.2 takes place on the basis of an electrical, mechanical, hydraulic, pneumatic or combined input variable—in particular via control of the corresponding actuator 68, 68.1, 68.2. The input variable, which is coupled/synchronized on both sides via coupled actuators 68.1, 68.2, an actuator 68 with coupling mechanism or a controller 82, for example, is transmitted synchronously to the respective converter 32.1, 32.2 via a distributor 84.1, 84.2. The converter 32.1, 32.2 translates the input variable into a torque which is transmitted to the respective shaping element 14.1, 14.2 and results in an inward rotation in angular synchronism in opposite directions. The distributor 84.1, 84.2 formed in particular by the respective distributor rail 42.1, 42.2 has a free linear guide so that the individual converters 32.1, 32.2 can be moved independently of one another in the longitudinal direction.

With the aid of the angularly synchronous rotation of the shaping elements 14.1, 14.2 in mutually opposite directions, the wire is bent in the plane (flat winding) as already described in principle in [4]. On the basis of the guidance of each shaping element 14.1, 14.2, the non-linear longitudinal movement resulting from the angularly synchronous rotation of the shaping elements 14.1, 14.2 can simply be compensated automatically.

As described in [4], the mutual rolling along the pitch curve 72 also leads to a continuous tension in the wire 18.

FIG. 6 illustrates the distribution and conversion of the input signal via the basic kinematics, whereby these processes take place independently of the contour of the shaping element 14.1 14.2. One advantage is the flexibility of the concept, since geometric modifications can be made to the shaping elements 14.1, 14.2 without requiring adjustment and remanufacture of the basic kinematics 80.1, 80.2.

In addition, compared to [4], the shaping elements 14.1, 14.2 become significantly more cost-efficient due to the elimination of the toothing. On the one hand, the time required to adapt the design and manufacture is decisively reduced, and on the other hand, cost- and time-intensive production processes associated with a hardened toothing can be dispensed with. In addition, the shaping elements 14.1, 14.2 can be exchanged with the existing ones in the event of a design change by attaching them to the existing basic kinematics 80.1, 80.2.

In [4], the rotation of the shaping elements 14.1, 14.2 is the result of a non-linear longitudinal movement, which is introduced at the guide carriage via an actuator. In contrast, the designs of the wave winding production device 10 shown here provide for synchronous initiation of the angle of rotation independent of the position of the shaping element 14.1, 14.2. The non-linear longitudinal movement results from rotation and is compensated for by the linear guide mechanism 12. Therefore, the exact equation of motion can remain unknown and does not need to be calculated or programmed. This simplifies control of the actuators 68, 68.1, 68.2, since they now introduce linear rather than nonlinear motion or forces. Furthermore, the control is independent of the contour of the shaping element 14.1, 14.2, making a one-time programming of the control 82 sufficient. Thus, changes to the shaping element 14.1, 14.2 can be tested more quickly on the prototype and series systems can be adapted more quickly to new stators.

In the illustrated embodiments of the wave winding production device 10, control is effected by means of a preferably electromechanical actuator 68, 68.1, 68.2. The force which is introduced is transmitted synchronously to the lever kinematics 48 of each shaping element 14.1, 14.2 via at least one distributor rail 42.1, 42.2. The lever kinematics 48 here represents the converter 32.1, 32.2 from FIG. 6 and translates the introduced force into a torque that is transmitted to the corresponding shaping element 14.1, 14.2. With the aid of the linear guide mechanism 12 and the groove 44 in the distributor rail 42.1, 42.2, the torque is applied and synchronized independently of the position of the shaping element 14.1, 14.2. At the same time, the separate guide of each shaping element 14.1, 14.2 can be used to compensate for the non-linear longitudinal movement resulting from the rotation of the shaping elements 14.1, 14.2.

As described in [4], the mutual rolling along the pitch curve 72 also results in a continuous tension in the wire 18. However, the lever kinematics 48 is independent of the geometry of the shaping element 14.1, 14.2, thereby increasing the ease of modification.

In some embodiments, in order to establish the contact between the shaping elements 14.1, 14.2 even during idle operation, a force (pressing force) is introduced into the longitudinal direction of the linear guide 26 of the shaping elements 14.1, 14.2. Furthermore, the additional force in the longitudinal direction has the advantage that it can provide support during the bending process and thereby compensate for the rolling resistance of the guide carriages.

Possible configurations for introducing the pressing force are explained below with reference to FIGS. 7 to 12.

According to the embodiments shown in FIGS. 6 to 12, the wave winding production device 10 has a pressing force introduction device 86 which is designed to introduce a pressing force 74 for maintaining the support of neighboring shaping elements 14.1, 14.2 via the pitch curve 72 when the shaping elements 14.1, 14.2 are moved together and/or when they are moved apart.

In some embodiments, such as those shown in FIGS. 7 to 10, the pressing force introduction device 86 is configured to introduce a force that is independent of the direction of rotation of the shaping elements 14.1, 14.2 into a guide carriage 40.1, 40.2 of at least one outer shaping element 14.1, 14.2 of the row of shaping elements 14.1, 14.2, which guide carriage is movable on the linear guide mechanism 12.

In some embodiments, as shown in particular in FIGS. 9, 11 and 12, the pressing force introduction device 86 is configured to introduce a pressing force 74 by moving a plurality of shaping elements towards each other.

In some embodiments, as shown in particular in FIGS. 11 and 12, the pressing force introduction device 86 has at least one preferably elastic clamping device 88 for introducing a clamping force 90 for clamping together adjacent form elements 14.1, 14.2.

Designs of the wave winding production device 10, as shown for example in FIGS. 7 to 12, comprise a mechanism for linear positioning of the shaping elements 14.1, 14.2. The mechanism for linear positioning has in particular the effect that an initial setup of the wave winding production device, an inward movement and/or a return movement is easily enabled even “in idle mode”, i.e. in particular without an inserted wire 18.

For example, the positive locking of the toothing described in [4] during the approaching movement is only given when the shaping elements are fitted with at least one wire. A similar effect results in embodiments of the present wave winding production device according to FIGS. 1 to 6 with the pitch curves 72 or other support via other control cams 70. The wire 18 restricts a further degree of freedom of the shaping elements 14.1, 14.2, so that the pitch curves 72 are pressed against each other—and in the case of prior art according to [4] the engaging teeth—and cannot slide against each other. The longitudinal force introduced for the approaching movement results in a relative force between the pitch curves 72. These relative forces result in the respective displacement of the shaping elements in the embodiments of the wave winding production device 10 described herein. When there is no wire, as for example in an idle operation, neighboring shaping elements 14.1, 14.2 can become disengaged, whereby the kinematic coupling is interrupted and a synchronized movement is disturbed.

The situation also becomes apparent in the case of an empty approach to the initial position following the last shaping step, such as in particular counter-bending, and after removal of the bent wave winding wire. By applying a force to the guide carriage 40.1, 40.2 of an outer shaping element 14.1, 14.2, the shaping elements 14.1, 14.2 become disengaged, whereby in particular the contact between the pitch curves 72 is omitted. As a result, both the kinematic coupling between the neighboring shaping elements 14.1, 14.2 and the coupling between the rotation and the linear movement of a single shaping element 14.1, 14.2 are omitted, since the latter is based on the relative forces between the pitch curves 72. Consequently, automated approach of the initial position purely with contact via pitch curves 72 is difficult without further measures.

As described above, the flexibility of the shaping elements 14.1, 14.2 can be increased with the aid of basic kinematics 80.1, 80.2, which control the rotation independently of the linear position of the shaping elements 14.1, 14.2. However, the linear compensation/freewheel also leads to a decoupling of the shaping elements 14.1, 14.2 along the longitudinal direction. This makes it particularly difficult to approach the initial position, since the basic kinematics 80.1, 80.2 only guarantee a synchronized angular position, but do not position the shaping elements 14.1, 14.2 linearly.

Some embodiments of the wave winding production device 10, as shown in particular in FIGS. 7 to 12, comprise a mechanism that positions a certain number of shaping elements 14.1, 14.2 relative to each other with as few actuators as possible. The positioning can be performed reliably with and without wire and when the shaping elements 14.1, 14.2 are moved apart as well as when they are moved together. Preferably, the mechanism does not depend on the number of shaping elements 14.1, 14.2, the geometry of the shaping elements 14.1, 14.2, the movement curves or the spacings between the shaping elements 14.1, 14.2, so that the flexibility of the basic kinematics 80.1, 80.2 is not limited.

In embodiments of the wave winding production device 10, due to the numerous requirements with respect to flexibility, this is done by means of the shaping elements 14.1, 14.2 themselves with the aid of the pitch curves 72 already described in principle in [4]. In embodiments of the wave winding production device 10, a coupling of the shaping elements 14.1, 14.2 is created by introducing an external force—pressing force 74—or an external stroke, which presses the pitch curves 72 of the neighboring shaping elements 14.1, 14.2 against each other both when moving apart and when moving together. As a result, the shaping elements 14.1, 14.2 are positioned exclusively as a function of the angular position.

For example, in order to guarantee contact between the shaping elements 14.1, 14.2 both when idle and when moving apart in the direction of the initial position, in some embodiments of the wave winding production device 10 a force or stroke independent of the direction of rotation is introduced at the guide carriages 40.1, 40.2 of the outer shaping elements 14.1, 14.2. The force or stroke must be selected as large and must be oriented in such a way that the pitch curves 72 of all neighboring shaping elements 14.1, 14.2 are continuously pressed against each other both when moving apart and when moving together, and permanent contact is ensured. An upper limit for the force is determined by the fact that it must be overcome when the elements are moved apart.

With the aid of the introduced longitudinal force or the introduced longitudinal stroke, idling operation and automated return to the initial position are enabled. The advantages of idle operation have a particular effect on commissioning and on process analysis. For example, the axes (in terms of movement axes of the wave winding production device 10 with setting of associated actuators/limiters) can be run in without the use of a wire, reducing scrap and saving costs. Similarly, scrap is reduced when initial test runs and investigations into the mechanical losses within the kinematics can be performed at idle.

In principle, there are several variants for ensuring contact between the pitch curves of the shaping elements, some of which are shown in FIGS. 7 to 12. Although only three shaping elements 14.1, 14.2 are shown in each of FIGS. 7 to 12, it should be clear that in practice a much larger number of shaping elements 14.1, 14.2 are provided in the row. The variants differ on the basis of the following criteria, with further variants being created by different combinations of the criteria:
Number of force application points
Type of control
Direction of movement of the carriages 40.1, 40.2

A first exemplary embodiment of the wave winding production device 10 provided with pressing force application device 86 is shown in FIGS. 7 and 8. In FIG. 7, the row of form elements 14.1, 14.2 can be seen from the side in the initial position and in FIG. 8 from above in the end position. For clarity, only the first three shaping elements are shown as seen from the right in FIGS. 7 and 8.

In the example of the wave winding production device 10 shown in FIGS. 7 and 8, the guide carriage 40.1 of an external shaping element 14.1 (here the right-hand guide carriage) is fixed and operated as a fixed bearing. With the aid of a pressing force actuator 92, a force—pressing force 74—or a corresponding stroke is introduced at the guide carriage 14.1 there at the opposite end of the shaping element chain, resulting in the counterforce at the fixed bearing and pressing the shaping elements 14.1, 14.2 against each other. As a result, the shaping elements 14.1, 14.2 perform a non-linear translation to the right in addition to the rotation when the wire 18 is bent. Due to the mutual clamping of all shaping elements 14.1, 14.2, only one actuator is required as pressing force actuator 92 for initiation. This can be implemented, for example, via an NC axis with belt drive or with a pneumatic cylinder and thus path- or force-controlled.

FIG. 8 shows the shaping elements 14.1, 14.2 in the compressed state. In order to approach the initial position, a torque is transmitted to each shaping element 14.1, 14.2 by means of the lever kinematics 48 described above. Simultaneously, the pressing force actuator initiates a force or stroke at the outer shaping element 14.1, further pressing the shaping elements 14.1, 14.2 against each other and coupling the longitudinal movement of the shaping elements 14.1, 14.2 with their rotation. In this way, each shaping element 14.1, 14.2 is not only rotated to its original angular position, but also moved to its initial position in the longitudinal direction.

A second exemplary embodiment for the wave winding production device 10 provided with the pressing force introducing device 86 is described below with reference to the illustration in FIG. 9. In the second exemplary embodiment, the controlled introduction of a force or a stroke takes place at the two guide carriages 14.1 of the outer shaping elements 14.1, with the forces or strokes acting in opposite directions and also differing in terms of the amount. As a result, the pitch curves 72 of the shaping elements 14.1, 14.2 are initially pressed against each other. At the same time, the entire shaping element chain can be displaced on the linear guide during bending and, for example, moved into a counter-bending device for counter-bending the wire (as known in principle, for example, from FIG. 10 of document [4]). In addition to the above-mentioned possibilities for implementing a press force actuator 92 for force-controlled or displacement-controlled initiation, a ball screw drive with servo drive can also be used, for example, for moving the outer guide carriages 40.1 together and apart.

Irrespective of the two initiation points, the movement for approaching the initial position is transmitted via the lever kinematics 48 as a torque to the respective shaping element 14.1, 14.2, as a result of which the shaping elements 14.1, 14.2 “unfold”. The introduced longitudinal force or longitudinal stroke presses the shaping elements 14.1, 14.2 against each other only along the pitch curves 72. In this way, each shaping element 14.1, 14.2 is not only rotated to the original angular position, but also moved to the initial position in the longitudinal direction.

A third exemplary embodiment for the wave winding production device 10 provided with pressing force introduction device 86 is shown below with reference to the illustration in FIG. 10. In the third exemplary embodiment, one of the outer guide carriages 40.1 is fixed and a separate force is introduced at each other guide carriage 40.1, 40.2 in the direction of the fixed guide carriage 40.1, resulting in a counterforce at the fixed bearing. In the case of synchronized force introduction, the bracing results in continuous contact of the shaping elements 14.1, 14.2 along the pitch curves 72. To simplify synchronization, the introduction should be force-controlled here. This is possible, for example, via a counterbalance or several pneumatic cylinders.

When the initial position is approached, the forces also act in the directions shown, pressing the shaping elements 14.1, 14.2 against each other along the pitch curves 72. In this way, each shaping element 14.1, 14.2 is not only rotated to the initial angular position, but also moved to the initial position in the longitudinal direction.

FIGS. 11 and 12 show a fourth and fifth exemplary embodiment for the wave winding production device 10 provided with pressing force introduction device 86. Here, the contact along the pitch curve 72 is controlled via the spacing of the guide carriages 40.1, 40.2 from each other. In principle, this can be realized both force-controlled and/or path-controlled and, in the simplest case, with the aid of tension springs—design example for the tensioning device 88. In addition, both a fixation (FIG. 11) and a controlled guidance (FIG. 12) at one of the outer carriages 40.1 are conceivable.

Here, too, the approach to the initial position is introduced via the lever kinematics 48 and the rotating shaping element 14.1, 14.2. In this case, the introduced force or stroke leads to compression of the pitch curves 72. In this way, each shaping element 14.1, 14.2 is not only rotated to the original angular position, but also moved to the initial position in the longitudinal direction.

Further embodiments of the wave winding production device and the wave winding manufacturing process that can be performed with it are explained below with reference to the illustration in FIGS. 13 and 14.

In FIGS. 13 and 14, a further embodiment for the wave winding production device 10 is shown, which is designed for producing wave winding wires for a coil winding of an electrical machine via flat winding and comprises the linear guide mechanism 12, for example of the type shown in FIGS. 1 to 6 or also as shown in [4], and the row of shaping elements 14.1, 14.2. As described above for the other embodiments, the shaping elements 14.1, 14.2 each have the holder 16 for holding a straight wire section of the wire 18 to be bent and the bending mold 20 for forming a wave winding head region between the straight wire sections. The shaping elements 14.1, 14.2 are linearly movable relative to each other on the linear guide mechanism 12 and are each rotatably mounted about an axis of rotation 22 so that, in operation, from a basic position shown in FIGS. 13 and 14 in which the holders of the shaping elements 14.1, 14.2 are aligned with each other, neighboring shaping elements 14.1, 14.2 rotate in opposite directions to each other and the shaping elements 14.1, 14.2 thereby approach each other with their axes of rotation, so as to form a meandering wave winding wire with straight wire sections and chevron-shaped wave winding heads therebetween from the wire 18 held in the holders. This can be done in the manner explained above with respect to the embodiments according to FIGS. 1 to 12, or as described and shown in any of the documents [2] to [4].

Some embodiments of the wave winding production device 10, an example of which is shown in FIGS. 13 and 14, further comprise a wire-end bending and fixing device 94 adapted to bend and positively fix the wire ends 96, 98 of the wire 18 to be bent inserted in the linearly aligned holders 16 to the associated outer shaping element 14.1 prior to the rotational movement of the shaping elements 14.1, 14.2.

As shown in FIG. 14, according to some embodiments of the wave winding production device 10, the wire-end bending and fixing device 94 is configured to bend the wire ends 96, 98 in such a way that wire ends 96, 98 protruding from the outer shaping elements 14.1 are offset parallel to the wire sections 100 received in the holder 16.

As shown in FIG. 14, according to some embodiments of the wave winding production device 10, the wire-end bending and fixing device is adapted to shape the wire ends 96, 98 at an outer bending mold 20 of the outer shaping elements 14.1, 14.2.

Particular effects, advantages and further optional features of these embodiments of the wave winding production device 10 with wire-end bending and fixing device 94 explained with reference to the example of FIGS. 13 and 14 will be described in more detail below.

Some embodiments of the wave winding production device 10 provide for fixation of wire ends 96, 98 of a wire bending device.

In preferred embodiments, the wave winding production device 10 is configured such that the contour of the shaping elements 14.1, 14.2 and thus also the end position of the wire 18 corresponds to the neutral fiber, so that the overall length of the wire 18 is not, or at least only insignificantly, changed by the bending. Since the bending radii of the shaping elements 14.1, 14.2 are comparatively small, the bending radii are not exactly shaped during “free” bending. The wire bends in a larger radius around the contour of the shaping elements 14.1, 14.2 and thus does not lie exactly in the neutral fiber before reverse bending. Due to the counter-rotation of the shaping elements 14.1, 14.2, the wire 18 is pressed against the bending radii, at least in the case of the inner shaping elements 14.1, 14.2, as a result of which it is positively fixed in the longitudinal direction. In contrast, in the previous prior art wave winding production devices, the wire ends 96, 98 of the outer shaping elements 14.1, 14.2 are “free” in the longitudinal direction at the time of flat winding, since up to now the forming of the wire ends 96, 98 only takes place parallel to the counter-bending. Due to the tensile stress in the bending heads, the wire ends 96, 98 are each pulled towards the center of the shaping element chain.

Particularly problematic here are uncontrolled and constantly changing draw-in lengths due to fluctuating wire bending properties of the wire 18 to be processed, which for cost reasons cannot be restricted too much, and the resulting different bending radii in the first step during free bending around the radii of the shaping elements 14.1, 14.2. 1, 14.2. Here, the differences are in the range of several millimeters and are therefore often not compatible with the requirements of a downstream laser welding process for fastening an interconnection element for the coil winding formed from the wave winding wires. To achieve the requirements for laser welding without introducing an additional cutting process, the positions of the wire ends 96, 98 are tolerated in the range of a few tenths. Furthermore, the permissible ranges of the edges up to which the wire ends 96, 98 are stripped before bending are also within narrow tolerances. These tolerances results, on the one hand, from the shortest possible overall length of the stator or other component and, on the other hand, from a certain minimum spacing between the stripped wire end and the laminated core of the stator or other component.

The problem of fixing the wire 18 lies less in the function itself than in the numerous boundary conditions. At this point, in some embodiments, a gripper (not shown) for loading and unloading the shaping elements 14.1, 14.2 should be mentioned. In some embodiments, such a gripper moves from above to the shaping elements 14.1, 14.2, grips the wires along the straight lengths and is moved in vertical direction. Therefore, fixing in vertical direction is complicated on the one hand by the required free space of the gripper, and on the other hand by the actuators, which initiates the force for fixing and releases the wire during loading and unloading. Bending the ends 96, 98 eliminates the need for a hold-down device.

If required, a hold-down device can still be added as an option. Horizontal clamping becomes complicated due to the different widths of the stacked wires and, taking into account the available installation space, almost impossible with small shaping elements 14.1, 14.2. Likewise, fixing the wire with the aid of an external mechanism is complex to implement, since the shaping elements 14.1, 14.2 change both the linear position and the angular position during bending. It must also be taken into account that the sensitive insulation of the wire 18 must not be damaged by the fixing process. Therefore, fixing with the aid of a force or friction fit is less suitable. Furthermore, the wire 18 has very good sliding properties, which in turn require very high clamping forces. Fixing the wire 18 in the longitudinal direction using a frictional connection is therefore severely limited due to the limited clamping force and the low coefficient of friction of the wire 18.

Some embodiments of the wave winding production device 10, an example of which is shown in FIGS. 13 and 14, have a slim and inexpensive mechanism which fixes the wire 18 in the outer shaping elements 14.1 at best positively, so that both the wire ends 96, 98 and the stripped areas are within the predetermined tolerances in a process-safe manner.

In particular, the process steps are rearranged for this purpose. In the first step, the wire ends 96, 98 are bent with the aid of the outer shaping elements 14.1. The bending process of the ends 96, 98 can be either external and/or integrated in the bending section. As a result, the wire 18 is positively fixed in the longitudinal direction of the shaping elements 14.1, 14.2 and can be moved in the vertical direction, i.e. inserted or removed, without additional actuators.

The wire 18 is fixed in the longitudinal direction at the wire ends 96, 98, which are bent by at least one, comparatively small, radius at the outer shaping elements 14.1 and thus positively fixed without the need for further components. At the same time, in this process step, the wire end 96, 98 is aligned in such a way that it can subsequently be welded to the interconnecting element.

Thus, a wave winding manufacturing process is carried out comprising:
aa) meandering bending of a wire 18 into a wave winding having straight wire sections 100 interconnected by wave winding heads, and
bb) bending wire ends 96, 98 of the wire 18,
wherein step bb) occurs before step aa).

In some embodiments of the method, it is provided that step bb) comprises positively fixing the wire ends 96, 98 to the outer shaping elements 14.1 of the wave winding production device 10 configured to perform step aa).

In some embodiments, step bb) is performed such that the bent-over wire ends 96, 98 are offset parallel to the next adjacent straight wire section 100. In particular, this allows the wires to be bent over to form connecting wires for connection to a switching element used to connect the coil winding formed from the wires to a power supply or driver.

The upstream bending of the wire ends 96, 98 results in several advantages. Firstly, the wire ends 96, 98 are bent into the desired positions so that initially their alignment matches that of the interconnection element. Secondly, the wire 18 is thereby positively fixed in the longitudinal direction of the shaping elements 14.1, 14.2, which ensures that no relative movement takes place between the outer shaping elements 14.1, 14.2 and the wire ends 96, 98 during flat winding. Also the positions of the stripped areas are thereby fixed relative to the outer shaping elements 14.1. Accordingly, the longitudinal position of the wire 18 when it is inserted into the shaping elements 14.1, 14.2 can already be selected in such a way that the wire mat formed from the winding wires can subsequently be fastened to an interconnection element with the aid of a laser welding process without requiring an additional cutting process. Furthermore, by bending the wire ends 96, 98 in advance, the function of clamping is fulfilled in a very simple and cost-neutral manner, since the actuators 102 (indicated by arrows in FIG. 13) for bending the ends must already be provided for the corresponding bending of the wire ends in previous processes anyway, too, and thus no additional components are required.

Accordingly, the wire end bending and fixing device 94 has the corresponding actuators 102 and the bending molds 20 on the outer shaping elements 14.1, 14.2 as well as the control unit 82, which is set up correspondingly and in which the instructions for frontloading the step of bending the ends 96, 98 are contained.

FIGS. 13 and 14 illustrate the positive fixing of the wire. FIG. 13 shows the initial position before fixing with the row of shaping elements 14.1, 14.2 (for illustration purposes only three are shown, in practice many more are provided), the wire 18 and the guide rail 38.1, 38.2 of the linear guide mechanism 12, while FIG. 14 shows the end position of the fixing operation, after fixing. This end position of the fixing operation corresponds to the initial position of the flat winding operation. During the fixing operation, the wire ends 96, 98 are respectively placed against the contour of the outer shaping elements 14.1 and counter-bent, so that the portions of the wire 18 which protrude from shaping elements are parallel to the central part of the wire 100 and the alignment thus fits the interconnection element.

Subsequently to the fixing operation, in preferred embodiments, flat winding is carried out with the wave winding production device 10 according to FIGS. 1 to 6 by driving the shaping elements 14.1, 14.2 to rotate by means of the basic kinematics 80.1, 80.2, as described above, and to displace linearly on the linear guide mechanism 12.

In some embodiments, the controller 82 is adapted to control the wave winding production device to perform the wave winding production process. For this purpose, in particular, a corresponding computer program is loaded into the controller 82.

In some embodiments, in particular, a wave winding production process for producing wave winding wires for a coil winding of an electric machine by flat winding is automatically performed, comprising the steps of:
a) providing the row of shaping elements 14.1, 14.2,
b) inserting a wire into the mutually aligned holders 16 of the shaping elements 14.1, 14.2,
c) driving opposite rotational movements of respectively neighboring shaping elements 14.1, 14.2 by changing the spacing of linear guides 26, 28, 34 of the linear guide mechanism 12 for guiding the linear movement of the shaping elements 14.1, 14.2 and converting the change in spacing into rotational movements of the shaping elements 14.1, 14.2, and
d) bending a meandering wave winding wire having straight wire sections 100 and chevron-shaped wave winding heads therebetween by the opposite rotational movements.

In some embodiments of the wave winding production method, step c) comprises the steps of:
guiding the linear movement of the shaping elements 14.1, 14.2 on the first linear guide 26 and displacing the second linear guide 28 and/or the third linear guide 34 relative to the first linear guide 26 in a direction transverse to the direction of linear movement of the shaping elements 14.1, 14.2, and
picking-off the relative displacement movement of the linear guides 26, 28, 34 by means of pick-off elements 36.1, 36.2 of converters 32.1, 32.2 mounted for displacement on the second and/or third linear guide 28, 34, which converts are respectively associated with the shaping elements 14.1, 14.2 and move along with the associated shaping elements 14.1, 14.2 in the direction of linear movement.

In some embodiments of the wave winding production method, the first linear guide 26 is thereby held stationary, and the second and/or third linear guides 28, 34 are moved toward and away from the first linear guide 26 as a distribution rail 42.1, 42.2.

In some embodiments of the wave winding manufacturing process, the linear position of the shaping elements 14.1, 14.2 relative to each other is adjusted by mutually supporting respective neighboring shaping elements 14.1, 14.2 on pitch curves 72.

Some embodiments of the wave winding production method further comprise the step of:
introducing a pressing force to maintain support of neighboring shaping elements 14.1, 14.2 over the pitch curves 72 as the shaping elements 14.1, 14.2 move together and/or as they move apart.

Introducing the pressing force 74 may comprise introducing a force independent of the direction of rotation of the shaping elements at a guide carriage 40.1 of at least one outer shaping element 14.1, which guide carriage is movable on a linear guide mechanism 12.

Introducing the pressing force 74 may further comprise introducing at least one additional force into at least one further guide carriage 40.1, 40.2 of a further shaping element 14.1, 14.2, which guide carriage is movable on the linear guide mechanism 12.

The introduction of the pressing force 74 may further comprise:
relative linear movement of several shaping elements 14.1, 14.2 and/or
introduction of a preferably elastic clamping force for clamping together neighboring shaping elements.

Devices (10) and methods for producing wave winding wires for a coil winding of an electrical machine via flat winding have been described, wherein a row of shaping elements (14.1, 14.2), each having a holder (16) for holding a straight wire section (100) of a wire (18) to be bent and a bending mold (20) for shaping a wave winding head region between the straight wire sections (100), are moved in a linear manner relative to one another on a linear guide mechanism (12) and are rotated about a respective axis of rotation (22), in order to form a meandering wave winding wire with straight wire sections and chevron-shaped wave winding heads in between from the wire (18) held in the holder (16) by rotating neighboring shaping elements (14.1, 14.2) in opposite directions with their axes of rotation (22) converging. In order to improve flexibility and/or process safety, according to one aspect of the invention, it is proposed to convert a change in spacing of linear guides (26, 28, 34) of the linear guide mechanism into the rotational movement of the shaping elements (14.1, 14.2). According to a further aspect, it is proposed to carry out a bending of the wire ends (96, 98) of the wire before the meandering bending of the wave winding wire in order to, in particular, easily fix the wire (18) for bending.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 wave winding production device
12 linear guide mechanism
14.1 first shaping element
14.2 second shaping element
16 holder
18 wire to be bent
20 bending mold
22 axis of rotation
24.1 first direction of rotation
24.2 second direction of rotation
26 first linear guide
28 second linear guide
30 converter mechanism
32.1 first converter
32.2 second converter
34 third linear guide
36.1 first pick-off element
36.2 second pick-off element
38.1 first guide rail
38.2 second guide rail
40.1 first guide carriage
40.2 second guide carriage
42.1 first distributor rail
42.2 second distributor rail
44 slot
46 roller
48 lever kinematics
50 distributor rail carriage
52 guide for distributor rail
54 pivot bearing
55 rotationally rigid connection
56 cantilever
58 lever unit
60 toggle lever
62 first toggle arm
64 second toggle arm
66 articulated joint
68 actuator
68.1 first actuator
68.2 second actuator
69 screw
70 mechanical control cam
72 pitch curve
74 pressing force
80.1 first basic kinematics
80.2 second basic kinematics
82 controller
84.1 first distributor
84.2 second distributor
86 pressing force introduction device
88 clamping device
90 clamping force
92 pressing force actuator
94 wire-end bending and fixing device
96 first wire end
98 second wire end
100 straight wire section
102 actuator (of the wire-end bending and fixing device)

1.-32. (canceled)

33. A wave winding device for producing wave winding wires for a coil winding of an electric machine via flat winding, the wave winding device comprising:
a linear guide mechanism; and
a row of shaping elements each having a holder for holding a straight wire section of a wire to be bent and a bending mold for shaping a wave winding head region between the straight wire sections, the shaping elements being linearly movable relative to each other on the linear guide mechanism and rotatably mounted about a respective axis of rotation in such a way that, from an initial position in which the holders of the shaping elements are aligned with respect to one another, respectively neighboring shaping elements rotate in mutually opposite directions and the shaping elements thereby approach one another with their axes of rotation in order to form a meandering wave winding wire with straight wire sections and chevron-shaped wave winding heads in between from the wire held in the holders,
wherein the linear guide mechanism comprises a first linear guide and a second linear guide, a spacing between which is variable,
wherein a conversion mechanism is further provided for converting a change in the spacing of the first linear guide and the second linear guide into a rotational movement of the shaping elements.

34. The wave winding device according to claim 33, wherein the converter mechanism has one converter for each shaping element to be rotated, which converter is mounted on the linear guide mechanism such that said converter moves with the associated shaping element.

35. The wave winding device according to claim 34, wherein the row of shaping elements comprises alternating first and second shaping elements, wherein the second shaping elements are adapted to rotate in opposite directions to the first shaping elements,
wherein the linear guide mechanism comprises a third linear guide, the first linear guide being disposed between the second and third linear guides, and the second and third linear guides movable toward and away from the first linear guide for driving the rotational movement,
wherein first converters for driving the rotational movement of the first shaping elements comprise first pick-off elements which are linearly movably mounted on the second linear guide, and second converters for driving the rotational movement of the second shaping elements comprise second pick-off elements which are linearly movably mounted on the third linear guide.

36. The wave winding device according to claim 34, wherein the converters comprise lever kinematics for converting the movement of the linear guides towards and away from each other into a rotational movement of the associated shaping elements.

37. The wave winding device according to claim 33, wherein the first linear guide has a stationary guide rail on which guide carriages are mounted in a freely displaceable manner, on each of which a shaping element is rotatably mounted with an axis of rotation,
wherein the second linear guide has a distributor rail which is mounted for displacement transversely to an extension of the guide rail.

38. The wave winding device according to claim 33, further comprising an actuator for changing the spacing of the linear guides of the linear guide mechanism.

39. The wave winding device according to claim 38, wherein the row of shaping elements comprises alternating first and second shaping elements, wherein the second shaping elements are adapted to rotate in opposite directions to the first shaping elements,
wherein the linear guide mechanism comprises a third linear guide, the first linear guide being disposed between the second and third linear guides, and the second and third linear guides movable toward and away from the first linear guide for driving the rotational movement,
wherein first converters for driving the rotational movement of the first shaping elements comprise first pick-off elements which are linearly movably mounted on the second linear guide, and second converters for driving the rotational movement of the second shaping elements comprise second pick-off elements which are linearly movably mounted on the third linear guide, and
further comprising:
a first actuator for driving the movement of the second linear guide and a second actuator coupled or synchronized with the first actuator for driving the movement of the third linear guide; or
a coupling mechanism for coupling the actuator to the second linear guide and the third linear guide.

40. The wave winding device according to claim 33, wherein the shaping elements are mounted for individual replacement on the linear guide mechanism.

41. The wave winding device according to claim 33, wherein the shaping elements are mounted freely displaceable relative to each other on the linear guide mechanism and that adjacent shaping elements are engaged with each other via at least one mechanical control cam in such a way that the relative displacement of the shaping elements to each other is driven through the rotation of the shaping elements.

42. The wave winding device according to claim 41, wherein neighboring shaping elements are designed to:
roll mutually on a pitch curve during the rotational movement; or
to bear against each other on pitch curves during an entire rotational movement for shaping the wave winding wire; or
both.

43. The wave winding device according to claim 42, further comprising a pressing force introduction device configured to introduce a pressing force for maintaining the support of neighboring shaping elements via the pitch curve when the shaping elements move together, move apart, or both.

44. The wave winding device according to claim 43, wherein the pressing force introduction device is configured to introduce a force independent of a direction of rotation of the shaping elements into a guide carriage of at least one outer shaping element of the row of shaping elements, which guide carriage is movable on the linear guide mechanism.

45. The wave winding device according to claim 44, wherein the other outer shaping element of the row of shaping elements is fixed to the linear guide mechanism, or the pressing force introduction device is configured to introduce a pressing force into at least one further guide carriage of a further shaping element, which guide carriage is movable on the linear guide mechanism, or both.

46. The wave winding device according to claim 43, wherein the pressing force introduction device:
is configured to introduce a pressing force by moving a plurality of shaping elements towards one another; or
has at least one elastic clamping device for introducing a clamping force for clamping together adjacent shaping elements; or
both.

47. A wave winding device for producing wave winding wires for a coil winding of an electric machine via flat winding, the wave winding device comprising:
a linear guide mechanism; and
a row of shaping elements each having a holder for holding a straight wire section of a wire to be bent and a bending mold for shaping a wave winding head region between the straight wire sections, the shaping elements being linearly movable relative to each other on the linear guide mechanism and rotatably mounted about a respective axis of rotation in such a manner that, from an initial position in which the holders of the shaping elements are aligned with respect to one another, respectively neighboring shaping elements rotate in mutually opposite directions and the shaping elements thereby approach one another with respective axes of rotation, in order to form a meandering wave winding wire with straight wire sections and chevron-shaped wave winding heads in between from the wire held in the holders,
and a wire-end bending and fixing device configured to bend wire ends of the wire to be bent inserted into the linearly aligned holders prior to a rotational movement of the shaping elements and to positively fix the wire ends to the associated outer shaping element.

48. The wave winding device according to claim 47, wherein the wire-end bending and fixing device is configured to bend the wire ends in such a way that wire ends projecting from outer shaping elements extend in an offset manner parallel to the wire sections received in the holder.

49. The wave winding device according to claim 47, wherein the wire-end bending and fixing device is configured to shape the wire ends on an outer bending mold of the outer shaping elements.

50. A method for producing wave winding wires for a coil winding of an electric machine via flat winding, the method comprising:
a) providing a row of shaping elements each having a holder for holding a straight wire section of a wire to be bent and a bending mold shaping a wave winding head region between the straight wire sections, the shaping elements being linearly movable relative to each other and rotatably supported about a respective rotation axis;
b) inserting a wire into the mutually aligned holders of the shaping elements;
c) driving opposite rotational movements of respectively adjacent shaping elements by changing a spacing of linear guides of a linear guide mechanism for guiding the linear movement of the shaping elements and converting a change in spacing into rotational movements of the shaping elements, and
d) bending a meandering wave winding wire having straight wire sections and chevron-shaped wave winding heads therebetween by the opposite rotational movements.

51. The method according to claim 50, wherein step c) comprises the steps of:
guiding the linear movement of the shaping elements on a first linear guide and displacing a second, or a third, or both a second and a third linear guide relative to the first linear guide in a direction transverse to the direction of linear movement of the shaping elements, and
picking-off relative displacement movement of the linear guides by means of pick-off elements of converters that are associated in each case with the shaping elements and move along with the associated shaping elements in the direction of linear movement.

52. The method according to claim 50, wherein in step c) the first linear guide is held stationary and the second, or the third, or both the second and the third linear guide are moved towards and away from the first linear guide as a distributor rail.

53. The method according to claim 20, wherein linear positions of the shaping elements relative to each other are adjusted by supporting respectively neighboring shaping elements against each other on pitch curves.

54. The method according to claim 53, further comprising:
introducing a pressing force for maintaining the support of neighboring shaping elements via the pitch curves when the shaping elements are moved together, moved apart, or both.

55. The method according to claim 54, wherein the introducing of the pressing force comprises introduction of a force independent of the direction of rotation of the shaping elements into a guide carriage of at least one outer shaping element, the guide carriage is movable on a linear guide mechanism.

56. The method according to claim 55, wherein the introducing of the pressing force further comprises introducing at least one additional force into at least one further guide carriage of a further shaping element, the at least one further guide carriage movable on the linear guide mechanism.

57. The method according to claim 54, wherein the introduction of the pressing force comprises:
a relative linear movement of a plurality of shaping elements; or
introducing an elastic clamping force for clamping together adjacent form elements; or
both.

58. The method according to claim 50, further comprising:
bb) meandering bending of a wire into a wave winding having straight wire sections interconnected by wave winding heads, and
aa) bending wire ends of the wire,
wherein step bb) is carried out before step aa).

59. The method according to claim 58, wherein step bb) comprises positively fixing the wire ends to outer shaping elements of a wave winding production device for carrying out step aa).

60. The method according to claim 58, wherein step bb) is performed such that the bent wire ends are offset parallel to the next adjacent straight wire section.

61. A non-transitory computer readable medium storing a computer program containing machine-readable instructions for causing a wave winding device to perform the method according to claim 50.
